(19) United States
(12) Patent Application Publication
(10) Pub. No.: US 2026/0074176 A1
(43) Pub. Date: Mar. 12, 2026

(54) METHOD OF MANUFACTURING A VEHICLE BATTERY WITH IMPROVED ELECTRODE CONDUCTIVITY

(71) Applicant: GM Global Technology Operations LLC, Detroit, MI (US)

(72) Inventors: Insun Yoon, Shelby Township, MI (US); Yifan Zhao, Troy, MI (US); Fang Dai, Troy, MI (US)

(73) Assignee: GM Global Technology Operations LLC, Detroit, MI (US)

(21) Appl. No.: 18/826,420

(22) Filed: Sep. 6, 2024

(51) Int. Cl. H01M 4/04; B60L 50/64; H01M 4/02; H01M 4/62; H01M 4/66

(52) U.S. Cl. CPC H01M 4/0404; B60L 50/64; H01M 4/0409; H01M 4/0411; H01M 4/622; H01M 4/625; H01M 4/661; H01M 2004/021; H01M 2220/20

(57) ABSTRACT

A method of manufacturing a battery includes providing a slurry including carbon nanotubes, a binder, and a solvent. Then, operating an ultrasonic homogenizer to form a suspension including the carbon nanotubes and the binder within the solvent. Then, applying a layer of the suspension to a current collector of the battery. Finally, with the layer of the suspension applied to the current collector, applying an electrode coating of the battery to the layer of the suspension.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a battery with enhanced electrode conductivity for a vehicle and a method for manufacturing the same. During operation of a battery, current collectors facilitate electric conductivity between the electrodes of the battery and external circuits. Traditionally, current collectors, such as those formed from aluminum or copper, naturally oxidize over the life of the battery. This increases interfacial resistance between the electrode, the current collector, and the external circuits, reducing conductivity and diminishing electrochemical performance of the battery.

Conventional carbon coatings applied to the current collector may reduce the potential for oxidation and/or increase the conductivity of the electrode. However, these carbon coatings typically result in a thickening of the current collector and undesirably participate in the electrochemical reactions of the battery. Furthermore, application of these carbon coatings is difficult and time consuming and results in poor uniformity and poor adhesion at the current collector.

### SUMMARY

One aspect of the disclosure provides a method of manufacturing a battery. The method includes providing a slurry including carbon nanotubes, a binder, and a solvent. Then, operating an ultrasonic homogenizer to form a suspension including the carbon nanotubes and the binder within the solvent. Then, applying a layer of the suspension to a current collector of the battery. Finally, with the layer of the suspension applied to the current collector, applying an electrode coating of the battery to the layer of the suspension.

Implementations of the disclosure may include one or more of the following optional features. In some examples, the solvent includes water.

In some implementations, the solvent includes N-Methylpyrrolidone (NMP).

In some aspects, the carbon nanotubes include one selected from the group consisting of (i) single-walled carbon nanotubes (SWCNTs), (ii) multi-walled carbon nanotubes (MWCNTs), and (iii) crosslink carbon nanotubes.

In some configurations, the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

In some examples, the suspension includes a percent weight of carbon nanotubes between 20 percent and 80 percent and a percent weight of binder between 20 percent and 80 percent.

In some implementations, the layer of the suspension at the current collector of the battery has a thickness between 0.1 micrometers and 10 micrometers.

In some aspects, the current collector includes at least one selected from the group consisting of (i) copper and (ii) aluminum.

In some configurations, applying the layer of the suspension to the current collector of the battery includes one selected from the group consisting of (i) doctor blade casting, (ii) slot die coating, (iii) reverse comma bar coating, and (iv) spin coating.

In some examples, the method further includes, with the layer of the suspension applied to the current collector, and before applying the electrode coating, curing the layer of the suspension at the current collector.

Another aspect of the disclosure provides a battery. The battery includes a current collector, a layer of a suspension disposed at the current collector, and an electrode coating electrically connected to the current collector. The layer of the suspension is applied to the current collector via a method. The method includes providing a slurry including carbon nanotubes, a binder, and a solvent including one selected from the group consisting of (i) water and (ii) N-Methylpyrrolidone (NMP). Then, the method further includes operating an ultrasonic homogenizer to form the suspension including the carbon nanotubes and the binder within the solvent. Then, the method further includes applying the layer of the suspension to the current collector of the battery. Finally, with the layer of the suspension applied to the current collector, the method further includes curing the layer of the suspension at the current collector. The electrode coating includes an active material applied to the cured layer of the suspension.

Implementations of this aspect of the disclosure may include one or more of the following optional features. In some examples, the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

In some implementations, the suspension includes a percent weight of carbon nanotubes between 20 percent and 80 percent and a percent weight of binder between 20 percent and 80 percent.

In some aspects, the cured layer of the suspension at the current collector of the battery has a thickness between 0.1 micrometers and 10 micrometers.

In some configurations, applying the layer of the suspension to the current collector of the battery includes one selected from the group consisting of (i) doctor blade casting, (ii) slot die coating, (iii) reverse comma bar coating, and (iv) spin coating.

Yet another aspect of the disclosure provides a vehicle. The vehicle includes a battery. The battery includes a current collector, a layer of a suspension disposed at the current collector, and an electrode coating electrically connected to the current collector. The layer of the suspension is applied to the current collector via a method. The method includes providing a slurry including carbon nanotubes, a binder, and a solvent including one selected from the group consisting of (i) water and (ii) N-Methylpyrrolidone (NMP). Then, the method further includes operating an ultrasonic homogenizer to form the suspension including the carbon nanotubes and the binder within the solvent. Then, the method further includes applying the layer of the suspension to the current collector of the battery. Finally, with the layer of the suspension applied to the current collector, the method further includes curing the layer of the suspension at the current collector. The electrode coating includes an active material applied to the cured layer of the suspension.

Implementations of this aspect of the disclosure may include one or more of the following optional features. In some examples, the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

In some implementations, the suspension includes a percent weight of carbon nanotubes between 20 percent and 80 percent and a percent weight of binder between 20 percent and 80 percent.

In some aspects, the cured layer of the suspension at the current collector of the battery has a thickness between 0.1 micrometers and 10 micrometers.

In some configurations, applying the layer of the suspension to the current collector of the battery includes one selected from the group consisting of (i) doctor blade casting, (ii) slot die coating, (iii) reverse comma bar coating, and (iv) spin coating.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a battery according to the present disclosure;

FIG. 2 is a perspective view of a battery cell of a battery according to the present disclosure;

FIG. 3 is a cross-section of an electrode of the battery taken along line 3-3 of FIG. 2;

FIG. 4 is a diagram of a suspension formed from a slurry using an ultrasonic homogenizer according to the present disclosure;

FIG. 5A is a topography chart of a carbon black-coated aluminum current collector;

FIG. 5B is a topography chart of an aluminum current collector without a coating;

FIG. 5C is a topography chart of a single-walled carbon nanotube-coated aluminum current collector with a water-based suspension according to the present disclosure;

FIG. 5D is a topography chart of a single-walled carbon nanotube-coated aluminum current collector with an N-Methylpyrrolidone-based suspension according to the present disclosure;

FIG. 6A is a conductivity map of the carbon black-coated aluminum current collector of FIG. 5A;

FIG. 6B is a conductivity map of the aluminum current collector of FIG. 5B without a coating;

FIG. 6C is a conductivity map of the single-walled carbon nanotube-coated aluminum current collector of FIG. 5C with the water-based suspension;

FIG. 6D is a conductivity map of the single-walled carbon nanotube-coated aluminum current collector of FIG. 5D with the N-Methylpyrrolidone-based suspension;

FIG. 7A is a topography chart of an electrode including an aluminum current collector without a coating;

FIG. 7B is a topography chart of an electrode including a single-walled carbon nanotube-coated aluminum current collector according to the present disclosure;

FIG. 8A is a conductivity map of the electrode including the aluminum current collector of FIG. 7A without a coating;

FIG. 8B is a conductivity map of the electrode including the single-walled carbon nanotube-coated aluminum current collector of FIG. 7B;

FIG. 9A is a chart showing coulombic efficiency and discharge capacity during the lifespan of a battery having an aluminum current collector without a coating;

FIG. 9B is a chart showing coulombic efficiency and discharge capacity chart during the lifespan of a battery having a carbon-coated aluminum current collector according to the present disclosure; and

FIG. 10 is a flow-chart of a method of manufacturing a battery according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

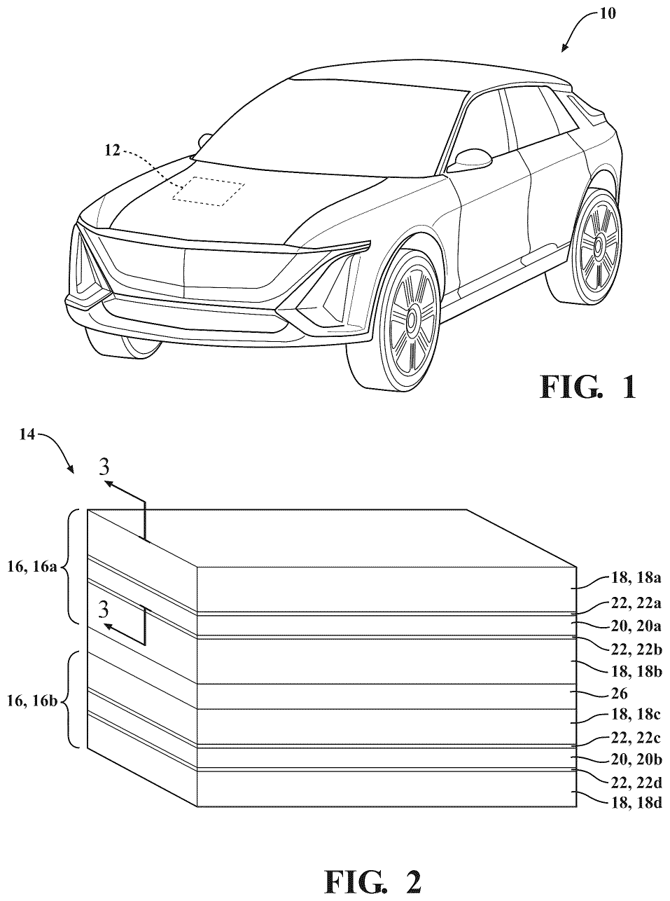

With reference to FIGS. 1-3, a vehicle 10 includes a battery 12 that electrically powers one or more components of the vehicle 10. For example, the vehicle 10 may be an electric vehicle or a plug-in hybrid vehicle or a hybrid vehicle, and the battery 12 may be a rechargeable battery, such as a lithium ion battery, that at least partially powers a propulsion system of the vehicle 10. Accordingly, the battery 12 receives electrical current to charge the battery 12, such as from an external charging device or an onboard charging system, and the battery 12 discharges electrical current to power the components of the vehicle 10.

The battery 12 includes one or more battery cells 14 that receive and discharge electrical current during operation of the battery 12. The battery cell 14 includes at least two electrodes 16 arranged in a layered configuration relative to one another. Each electrode 16 includes at least an electrode coating 18, a current collector 20, and a carbon nanotube layer 22 derived from a suspension 24, as discussed further below. In the illustrated example of FIG. 2, a first electrode 16, 16a of the battery cell 14 is an anode and a second electrode 16, 16b of the battery cell 14 is a cathode. The anode 16a and the cathode 16b are alternatingly arranged relative to one another within the battery cell 14 to facilitate a flow of ions between the anode 16a and the cathode 16b during charging and discharging of the battery 12. A separator 26 is disposed between the anode 16a and the cathode 16b. The current collector 20 facilitates the flow of electrical current between the battery cell 14 and the vehicle 10, while the electrode coating 18 includes an active material 19 and/or a conductive additive that facilitates the transfer of ions between the electrode coatings 18 and across the separator 26 responsive to the electrical load at the current collector 20. As discussed further below, the carbon nanotube layer 22 provides a thin, uniform, and conductive interface between the electrode coating 18 and the current collector 20 to improve conductivity of the battery cell 14.

As shown in FIG. 2, the anode 16a and the cathode 16b each include two layers of the electrode coating 18 disposed on opposing sides of the current collector 20. Respective carbon nanotube layers 22 are disposed between the current collector 20 and the electrode coating 18 at either side of the current collector 20. That is, the anode 16a includes a first electrode coating 18, 18a or an outboard anode coating and a second electrode coating 18, 18b or an inboard anode coating. The anode 16a electrically connects to a first current collector 20, 20a or an anode current collector with a first carbon nanotube layer 22, 22a or an outboard anode carbon nanotube layer disposed between the first current collector 20a and the first electrode coating 18a. Additionally, a second carbon nanotube layer 22, 22b or an inboard anode carbon nanotube layer is disposed between the first current collector 20a and the second electrode coating 18b. Similarly, the cathode 16b includes a third electrode coating 18, 18c or an inboard cathode coating and a fourth electrode coating 18, 18d or an outboard cathode coating. The cathode 16b electrically connects to a second current collector 20, 20b or a cathode current collector with a third carbon nanotube layer 22, 22c or an inboard cathode carbon nanotube layer disposed between the second current collector 20b and the third electrode coating 18c. Additionally, a fourth carbon nanotube layer 22, 22d or an outboard cathode carbon nanotube layer is disposed between the second current collector 20b and the fourth electrode coating 18d.

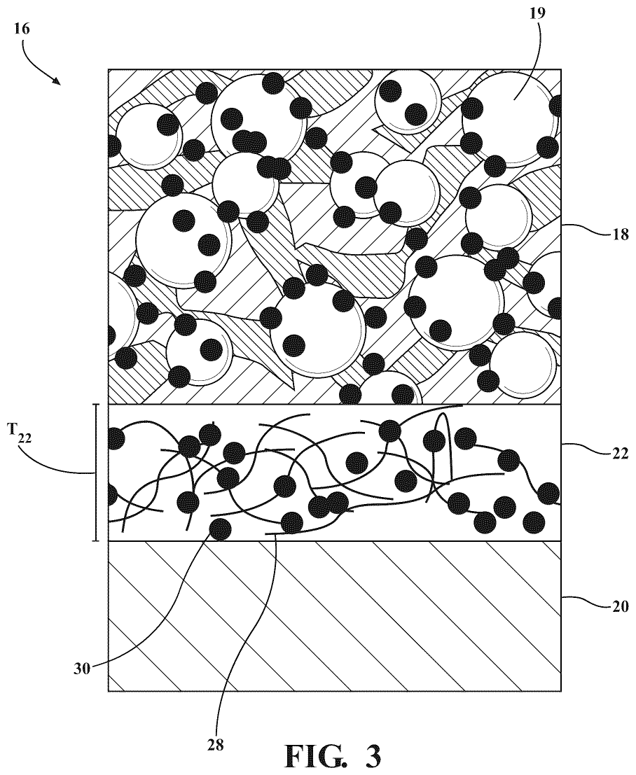

The carbon nanotube layers 22 are disposed at and interface with each respective side of the current collectors 20 within the battery cell 14. Further, each carbon nanotube layer 22 interfaces with a respective electrode coating 18 of the battery cell 14. The electrochemical interaction between the respective current collectors 20, carbon nanotube layers 22, and electrode coatings 18 of the anodes 16a and cathodes 16b of the battery cell 14 may be similar, such that the description of one carbon nanotube layer 22 and one electrode coating 18 at the current collector 20 (as shown in FIG. 3) may be representative of each electrode 16.

The current collector 20 may be formed from any suitable conductive material, such as copper, aluminum, or an alloy. In some examples, the current collector 20 may include a layer of aluminum foil or copper foil. The current collector 20 acts as an electrical conductor within the battery cell 14 of the battery 12 and supports the flow of electrical current across the battery cell 14.

With reference to FIGS. 2-4, the suspension 24 includes a binder 28 and a plurality of carbon nanotubes 30 suspended in a solvent 32. The binder 28 may include any suitable adhesive for use in the suspension 24 included in the battery 12, such as carboxy methyl cellulose (CMC), polyvinylpyrrolidone (PVP), polyvinylidene fluoride (PVDF), polyacrylic acid (PAA), and the like. Furthermore, the suspension 24 may include a percent weight of the binder 28 between twenty (20) percent and eighty (80) percent. The suspension 24 may include any suitable variety of carbon nanotube, such as single-walled carbon nanotubes (SWCNTs), multi-walled carbon nanotubes (MWCNTs), crosslink carbon nanotubes, and the like. The suspension 24 may include a percent weight of the plurality of carbon nanotubes 30 between twenty (20) percent and eighty (80) percent. The solvent 32 may include an aqueous solution or a non-aqueous solution. That is, the solvent 32 may include water and/or a non-water solvent such as N-Methylpyrrolidone (NMP).

Each carbon nanotube layer 22 has a layer thickness T₂₂ between 0.1 micrometers and ten (10) micrometers when applied at the current collector 20. For example, the first carbon nanotube layer 22a has the layer thickness T22 between 0.1 micrometers and ten (10) micrometers, and the second carbon nanotube layer 22b has the layer thickness T22 between 0.1 micrometers and ten (10) micrometers. The plurality of carbon nanotubes 30 and the binder 28 of the suspension 24 applied at the relatively thin layer thickness T22 enables strong and robust electric conductivity across the battery cell 14 while protecting the current collector 20 from oxidation buildup. By minimizing the potential for oxidation buildup on the current collector 20, the electric conductivity across the battery cell 14 may experience little to no deterioration over an extended period of use of the battery 12, as described in greater detail below.

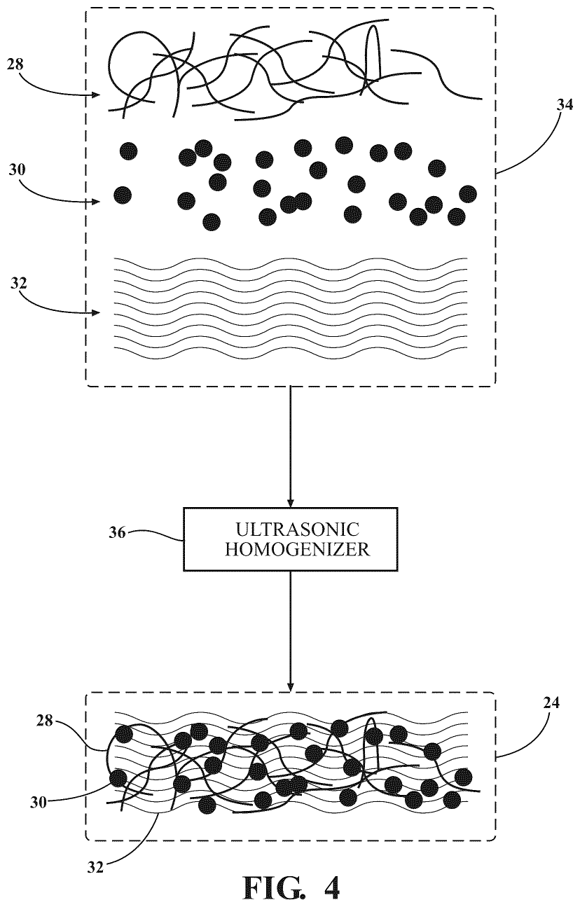

With reference to FIG. 4, the suspension 24 is prepared by providing a slurry 34 containing the binder 28, the plurality of carbon nanotubes 30, and the solvent 32. The slurry 34 is processed to suspend the carbon nanotubes 30 and the binder 28 within the solvent 32 with a substantially uniform distribution or homogenized manner. That is, the slurry 34 is transformed into the suspension 24. In the illustrated example, the slurry 34 is introduced to an ultrasonic homogenizer 36 and the ultrasonic homogenizer 36 is operated to produce the suspension 24. During operation of the ultrasonic homogenizer 36, the binder 28 and the plurality of carbon nanotubes 30 become suspended in the solvent 32 in the homogenized manner. Thus, the suspension 26 has a substantially uniform distribution of the plurality of carbon nanotubes 30 and the binder 28 within the solvent 32.

The suspension 24 is then applied to the current collector 20 and cured to form the carbon nanotube layer 22 at the surface of the current collector 20. For example, the suspension 24 may be applied to the current collector 20 via a process that includes doctor blade casting, slot-die coating, reverse comma bar coating, or spin coating. Using one or more of these application methods, together with the high uniformity of the suspension 24 (i.e., the carbon nanotubes 30 and/or the binder 28 are evenly distributed throughout the suspension 24), results in the layer thickness T22 of the cured carbon nanotube layer 22 being between 0.1 micrometers and ten (10) micrometers with uniform distribution of the carbon nanotubes 30 across the surface of the current collector 20.

Following curing or drying of the suspension 24, the solvent 32 may be removed from the suspension 24 and the carbon nanotube layer 22 remains at the current collector 20. In some examples, curing the suspension 24 includes an active curing process such as exposing the suspension 24 and the current collector 20 to elevated temperatures to cause the solvent 32 to evaporate (e.g., by placing the current collector 20 with applied suspension 24 in an oven, by directing heated airflow onto the suspension 24, and the like). Optionally, the active curing process may include exposing the suspension 24 and the current collector 20 to a vacuum to remove the solvent 32 from the suspension 24. In some examples, curing the suspension 24 to form the carbon nanotube layer 22 may include an inactive curing process, such as exposing the suspension 24 to ambient air and allowing the suspension 24 to naturally cure to form the carbon nanotube layer 22 at the current collector 20.

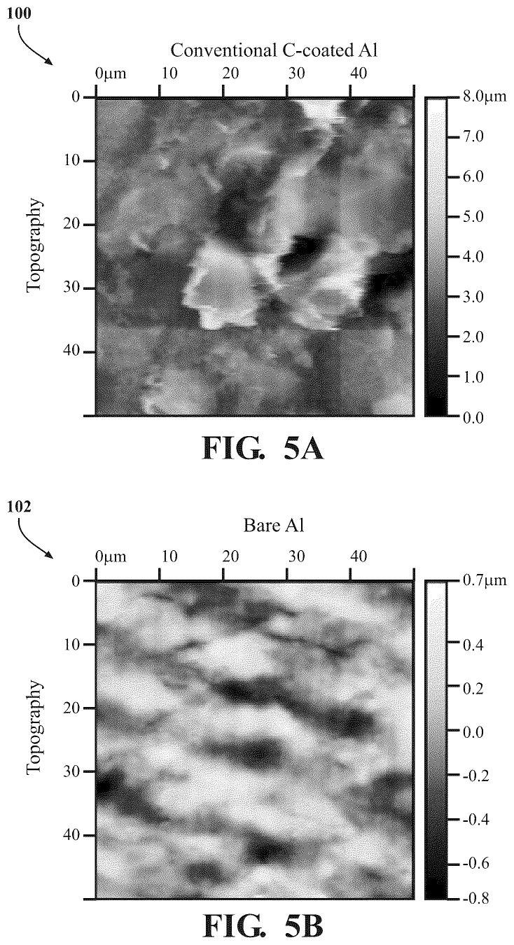

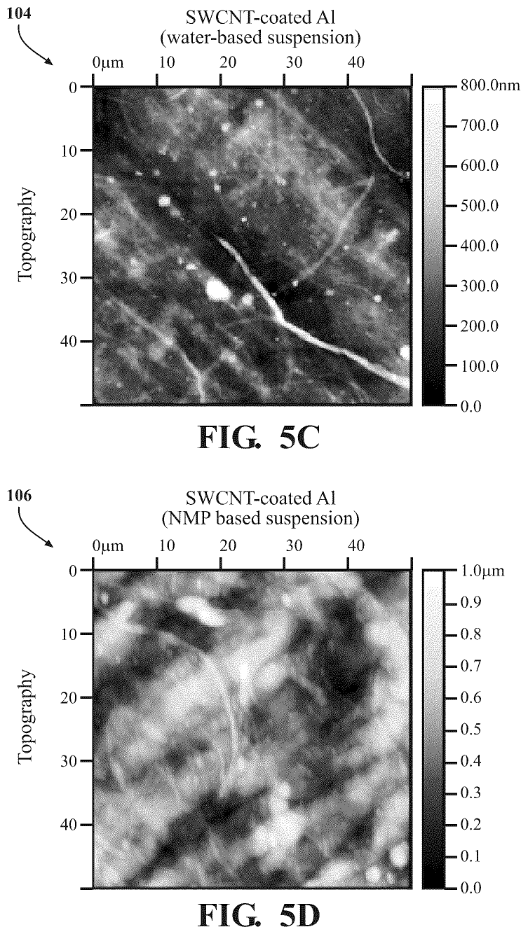

With reference to FIGS. 5A-5D, coating the current collector 20 with the carbon nanotube layer 22 using the suspension 24 results in a substantially uniform thickness of the carbon nanotube layer 22 and a substantially uniform surface smoothness of the carbon nanotube layer 22 across the current collector. For example, FIG. 5C depicts a topography chart 104 illustrating topography of the carbon nanotube layer 22 that is applied at the current collector 20 via an aqueous-based suspension 24. That is, the carbon nanotube layer 22 represented in the topography chart 104 is derived from a suspension 24 that includes water or a water-based solvent 32. The topography chart 104 represents a fifty (50) micrometer by fifty (50) micrometer sample of the carbon nanotube layer 22. As shown by the topography chart 104, topography of the carbon nanotube layer 22 only varies by about 800 nanometers, or 0.8 micrometers, illustrating a relatively uniform topography. That is, surfaces or features of the carbon nanotube layer 22 derived from the aqueous-based suspension 24 may only vary in height at the current collector 20 by about 800 nanometers or less.

FIG. 5D depicts a topography chart 106 illustrating topography of the carbon nanotube layer 22 that is applied at the current collector 20 via an NMP-based suspension 24. That is, carbon nanotube layer 22 represented in the topography chart 106 is derived from a suspension 24 that includes NMP or an NMP-based solvent 32. The topography chart 106 represents a fifty (50) micrometer by fifty (50) micrometer sample of the carbon nanotube layer 22. As shown by the topography chart 106, topography of the carbon nanotube layer 22 only varies by about one (1) micrometer, illustrating a relatively uniform topography. That is, surfaces or features of the carbon nanotube layer 22 derived from the NMP-based suspension 24 may only vary in height at the current collector 20 by about one (1) micrometer or less.

By contrast, FIG. 5A depicts a topography chart 100 illustrating topography of carbon that has been coated on an aluminum current collector using traditional means, such as spray coating or chemical vapor disposition (CVD) coating. Furthermore, the carbon illustrated in the topography chart 100 is free of nanotubes. The topography chart 100 represents a fifty (50) micrometer by fifty (50) micrometer sample of the carbon at the current collector. As shown by the topography chart 100, topography of the carbon varies by about eight (8) micrometers, illustrating a relatively uneven or non-uniform topography. That is, surfaces or features of the carbon layer deposited onto the current collector using traditional means may vary in height at the current collector by about eight (8) micrometers or more. Uneven and non-uniform topography of the carbon at the current collector results in inconsistent and weak electric conductivity across the electrode with increased interfacial resistance, which may result in a battery that has reduced discharge capacity and a diminished lifespan.

FIG. 5B depicts a topography chart 102 illustrating topography of a bare aluminum current collector that does not include a carbon coating. That is, when included in a battery, the bare aluminum current collector directly engages with the electrode coating. In this regard, the aluminum current collector is susceptible to corrosion and deterioration, such as oxidation, over the life of the battery. Oxidation increases interfacial resistance between the aluminum current collector and the electrode coating, reducing conductivity and diminishing electrochemical performance of the battery. The topography chart 102 represents a fifty (50) micrometer by fifty (50) micrometer sample of the bare aluminum current collector. As shown by the topography chart 102, topography of the bare aluminum current collector varies by about 0.7 micrometers. That is, surfaces or features of the bare aluminum current collector may vary in height by about 0.7 micrometers or less. Topography of the bare aluminum current collector is thus similar to topography of the water-based carbon nanotube layer 22 represented in topography chart 104 and the NMP-based carbon nanotube layer 22 represented in topography chart 106. Thus, the carbon nanotube layer 22 derived from the suspension 24 may provide greater protection from corrosion and deterioration with substantially similar surface uniformity as compared to the bare aluminum current collector.

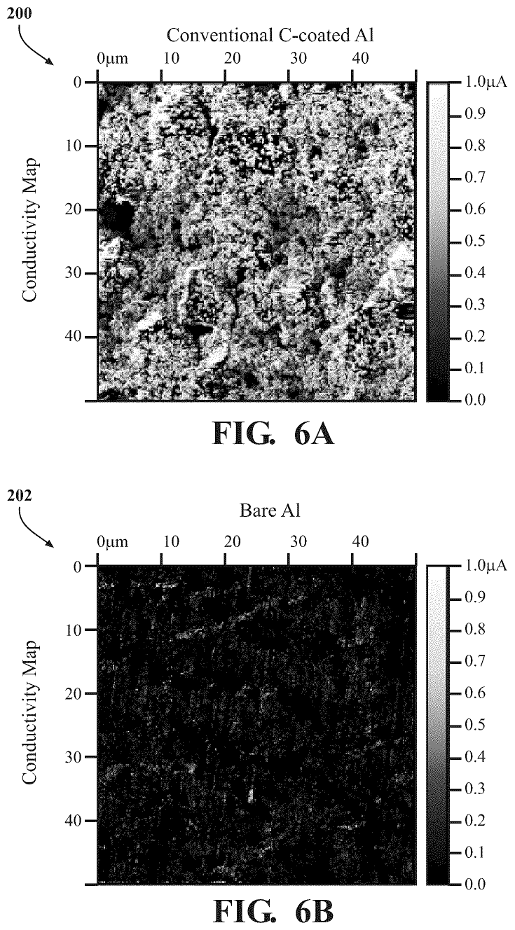

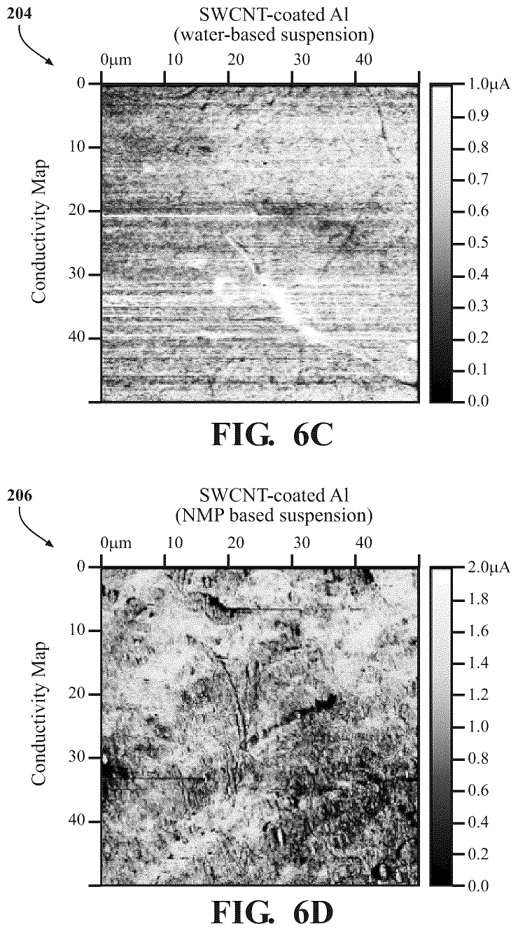

Referring to FIGS. 6A-6D, uniform thickness and smoothness of the carbon nanotube layer 22 at the current collector 20 results in consistent and robust electric conductivity across the electrode 16 with minimal interfacial electrical resistance. For example, FIG. 6C depicts a conductivity chart 204 illustrating conductivity of the carbon nanotube layer 22 that is applied at the current collector 20 via an aqueous-based suspension 24. That is, the carbon nanotube layer 22 represented in the conductivity chart 204 is derived from a suspension 24 that includes water or a water-based solvent 32. The conductivity chart 204 represents a fifty (50) micrometer by fifty (50) micrometer sample of the carbon nanotube layer 22. As shown by the conductivity chart 204, conductivity at the carbon nanotube layer 22 is relatively consistent and uniform at about one (1) microampere across the conductivity chart 204. In other words, the conductivity chart 204 indicates a majority of illustrated conductivity is closest to one (1) microampere. In this regard, measured conductivity does not erratically vary, indicating consistent, uniform, and strong conductivity at the carbon nanotube layer 22.

FIG. 6D depicts a conductivity chart 206 illustrating conductivity of the carbon nanotube layer 22 that is applied at the current collector 20 via an NMP-based suspension 24. In other words, the carbon nanotube layer 22 represented in the conductivity chart 204 is derived from a suspension 24 that includes NMP or an NMP-based solvent 32. The conductivity chart 206 represents a fifty (50) micrometer by fifty (50) micrometer sample of the carbon nanotube layer 22. As shown by the conductivity chart 206, conductivity at the carbon nanotube layer 22 is relatively consistent and uniform at about two (2) microamperes. That is, the conductivity chart 206 indicates a majority of illustrated conductivity is closest to two (2) microamperes. In this regard, measured conductivity does not erratically vary, indicating consistent, uniform, and strong conductivity at the carbon nanotube layer 22.

By contrast, FIG. 6A depicts a conductivity chart 200 illustrating conductivity of carbon that has been coated on an aluminum current collector using traditional means, such as spray coating or chemical vapor disposition (CVD) coating. Furthermore, the carbon illustrated in the conductivity chart 200 is free of nanotubes. The conductivity chart 200 represents a fifty (50) micrometer by fifty (50) micrometer sample of the carbon at the current collector. As shown by the conductivity chart 200, conductivity at the carbon varies between about zero (0) microamperes and about one (1) ampere, illustrating a relatively uneven or non-uniform conductivity. Furthermore, much of the conductivity illustrated at the conductivity chart 200 shows conductivity close to zero (0) microamperes. Inconsistent conductivity of the carbon coating results in inconsistent and weak electric conductivity across the electrode with increased interfacial resistance.

FIG. 6B depicts a conductivity chart 202 illustrating conductivity of a bare aluminum current collector that does not include a carbon coating. The conductivity chart 202 represents a fifty (50) micrometer by fifty (50) micrometer sample of the bare aluminum current collector. As shown by the conductivity chart 202, conductivity of the bare aluminum current collector is nearly consistent at about zero (0) microamperes. This indicates extremely poor conductivity at the bare aluminum current collector, which results in inconsistent and weak electric conductivity across the electrode with increased interfacial resistance.

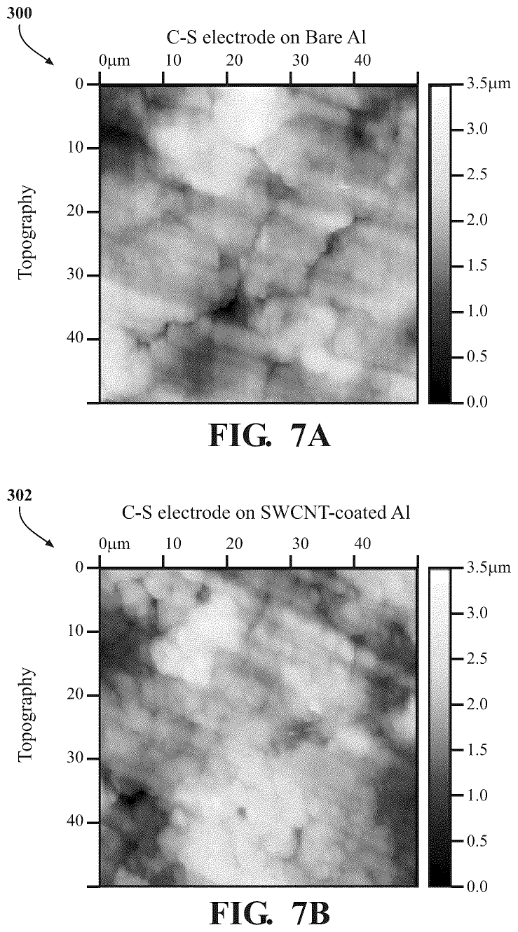

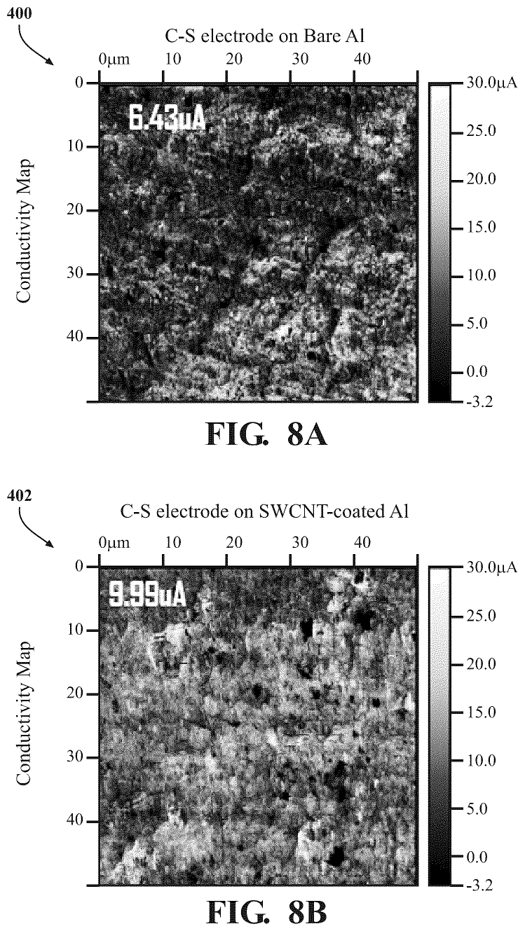

Referring to FIGS. 7A and 7B, topography of the electrode coating 18 is minimally affected when applied to the carbon nanotube layer 22 as compared to being applied to bare aluminum. For example, FIG. 7A depicts a topography chart 300 illustrating topography of an electrode coating applied to a bare aluminum current collector. The topography chart 300 represents a fifty (50) micrometer by fifty (50) micrometer sample of the electrode coating at the bare aluminum current collector. As shown by the topography chart 300, topography of the electrode coating varies between about zero (0) micrometers and 3.5 micrometers. FIG. 7B depicts a topography chart 302 illustrating topography of the electrode coating 18 that is applied to the carbon nanotube layer 22 at the current collector 20. That is, the carbon nanotube layer 22 is disposed between the electrode coating 18 and the current collector 20. The topography chart 302 represents a fifty (50) micrometer by fifty (50) micrometer sample of the electrode coating 18 at the carbon nanotube layer 22. As shown by the topography chart 302, topography of the electrode coating 18 varies between about zero (0) micrometers and 3.5 micrometers.

As shown by FIGS. 7A and 7B, adding the carbon nanotube layer 22 between the current collector 20 and the electrode coating 18 may not substantially affect the topography of the electrode coating 18. In other words, the electrode coating 18 may be relatively smooth and uniform regardless if it is applied to a bare aluminum current collector, or applied to the current collector 20 with the carbon nanotube layer 22 present between the current collector 20 and the electrode coating 18.

Referring to FIGS. 8A and 8B, conductivity of the electrode coating 18 is improved by the carbon nanotube layer 22 added to the current collector 20. For example, FIG. 8A depicts a conductivity chart 400 illustrating conductivity of an electrode coating applied to a bare aluminum current collector. The conductivity chart 400 represents a fifty (50) micrometer by fifty (50) micrometer sample of the electrode coating at the bare aluminum current collector. As shown by the conductivity chart 400, conductivity of the electrode coating varies between about negative 3.2 microamperes and thirty (30) microamperes, with the conductivity of a majority of the electrode coating measured between about five (5) amperes and ten (10) amperes. For example, the electrode may have an average conductivity of about 6.43 microamperes.

FIG. 8B depicts a conductivity chart 402 illustrating conductivity of the electrode coating 18 that is applied to the current collector 20 with the carbon nanotube layer 22 positioned between the electrode coating 18 and the current collector 20. The conductivity chart 402 represents a fifty (50) micrometer by fifty (50) micrometer sample of the electrode coating 18. As shown by the conductivity chart 402, conductivity of the electrode coating 18 varies between about negative 3.2 microamperes and thirty (30) microamperes, with the conductivity of a majority of the electrode coating 18 measured between about five (5) amperes and about twenty (20) amperes. For example, the electrode coating 18 may have an average conductivity of about 9.99 microamperes.

As shown by FIGS. 8A and 8B, the inclusion of the carbon nanotube layer 22 between the current collector 20 and the electrode coating 18 enhances the conductivity of the electrode coating 18. In other words, conductivity of the electrode coating 18 applied to the current collector 20 with the carbon nanotube layer 22 present between the current collector 20 and the electrode coating 18 may be greater compared to an electrode coating applied directly to a bare aluminum current collector. Greater conductivity at the electrode coating 18 results in greater electric conductivity across the electrode 16 with reduced interfacial resistance.

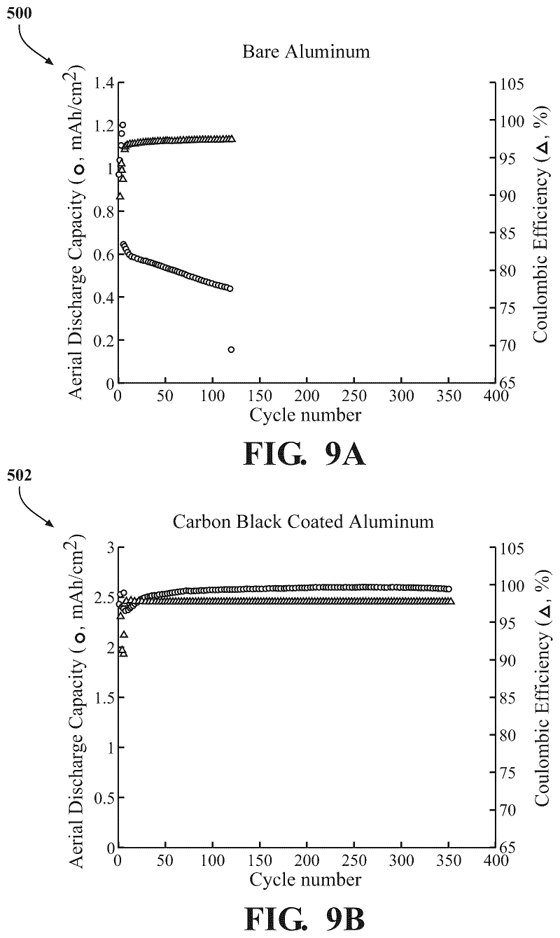

With reference to FIGS. 9A and 9B, the consistent and robust electric conductivity of the electrode 16 may directly correspond to the battery 12 of the vehicle 10 operating efficiently and robustly. That is, a carbon-coated current collector may result in an improved battery lifespan compared to a battery with a bare aluminum current collector that is free of a carbon coating. FIG. 9A depicts an efficiency chart 500 illustrating aerial discharge capacity and Coulombic efficiency across multiple cycles of a battery having a bare aluminum current collector. As the cycle number of the battery increases, Coulombic efficiency remains relatively steady as aerial discharge capacity decreases. For example, over the course of about 125 cycles of the battery, aerial discharge capacity reduces from about 1.2 mAh/cm², to about 0.45 mAh/cm². A drop in aerial discharge capacity may indicate weak cycling capabilities of the battery, which corresponds to a relatively short lifespan of the battery.

FIG. 9B depicts an efficiency chart 500 illustrating aerial discharge capacity and Coulombic efficiency across multiple cycles of the battery 12 that includes the carbon nanotube layer 22 between the current collector 20 and the electrode coating 18. As the cycle number of the battery increases, both Coulombic efficiency and aerial discharge capacity remains relatively steady. For example, over the course of about 350 cycles of the battery 12, aerial discharge capacity remains consistent around 2.5 mAh/cm². In other words, the battery 12 maintains its aerial discharge capacity over the course of about 350 cycles or more. As shown by FIGS. 9A and 9B, the battery 12 that includes the carbon nanotube layer 22 between the current collector 20 and the electrode coating 18 has a longer lifespan compared to a battery with a bare aluminum current collector.

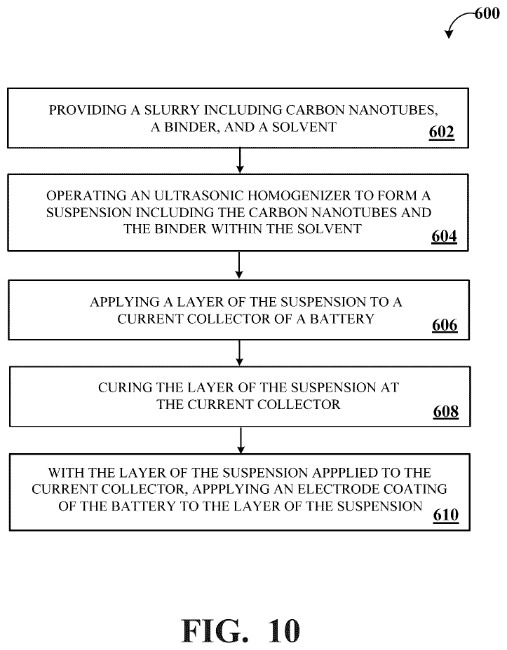

With reference to FIG. 10, a method of manufacturing the battery 12 is provided at 600. At operation 602, the method 600 includes providing the slurry 34 including the binder 28, the plurality of carbon nanotubes 30, and the solvent 32. At operation 604, the method 600 includes operating the ultrasonic homogenizer 36 to form the suspension 24 including the binder 28 and the plurality of carbon nanotubes 30 distributed and suspended within the solvent 32. At operation 606, the method 600 includes applying a layer of the suspension 24 to the current collector 20 of the battery 12. The layer of the suspension 24 may be applied at the current collector 20 via doctor blade casting, slot die coating, reverse comma bar coating, spin coating, or another suitable process to provide a uniform and smooth layer of the suspension 24 at the current collector 20. At operation 608, the method 600 includes curing the layer of the suspension 24 at the current collector 20. Curing the layer of the suspension 24 forms the carbon nanotube layer 22 at the current collector 20. At operation 610, and with the layer of the suspension 24 applied to the current collector 20, the method 600 includes applying the electrode coating 18 to the layer of the suspension 24. The electrode coating 18 may be applied after the layer of the suspension 24 is cured to form the carbon nanotube layer 22 at the current collector 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of manufacturing a battery comprising:
providing a slurry including carbon nanotubes, a binder, and a solvent;
operating an ultrasonic homogenizer to form a suspension including the carbon nanotubes and the binder within the solvent;
applying a layer of the suspension to a current collector of the battery; and
with the layer of the suspension applied to the current collector, applying an electrode coating of the battery to the layer of the suspension.

2. The method of claim 1, wherein the solvent includes water.

3. The method of claim 1, wherein the solvent includes N-Methylpyrrolidone (NMP).

4. The method of claim 1, wherein the carbon nanotubes include one selected from the group consisting of (i) single-walled carbon nanotubes (SWCNTs), (ii) multi-walled carbon nanotubes (MWCNTs), and (iii) crosslink carbon nanotubes.

5. The method of claim 1, wherein the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

6. The method of claim 1, wherein the suspension includes a percent weight of carbon nanotubes between 20 percent and 80 percent and a percent weight of binder between 20 percent and 80 percent.

7. The method of claim 1, wherein the layer of the suspension at the current collector of the battery has a thickness between 0.1 micrometers and 10 micrometers.

8. The method of claim 1, wherein the current collector includes at least one selected from the group consisting of (i) copper and (ii) aluminum.

9. The method of claim 1, wherein applying the layer of the suspension to the current collector of the battery includes one selected from the group consisting of (i) doctor blade casting, (ii) slot die coating, (iii) reverse comma bar coating, and (iv) spin coating.

10. The method of claim 1, further comprising, with the layer of the suspension applied to the current collector, and before applying the electrode coating, curing the layer of the suspension at the current collector.

11. A battery comprising:
a current collector, a layer of a suspension disposed at the current collector, the layer of the suspension applied to the current collector via a method comprising:
providing a slurry including carbon nanotubes, a binder, and a solvent including one selected from the group consisting of (i) water and (ii) N-Methylpyrrolidone (NMP);
operating an ultrasonic homogenizer to form the suspension including the carbon nanotubes and the binder within the solvent;
applying the layer of the suspension to the current collector of the battery; and
with the layer of the suspension applied to the current collector, curing the layer of the suspension at the current collector; and
an electrode coating electrically connected to the current collector, the electrode coating including an active material applied to the cured layer of the suspension.

12. The battery of claim 11, wherein the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

13. The battery of claim 11, wherein the suspension includes a percent weight of carbon nanotubes between 20 percent and 80 percent and a percent weight of binder between 20 percent and 80 percent.

14. The battery of claim 11, wherein the cured layer of the suspension at the current collector of the battery has a thickness between 0.1 micrometers and 10 micrometers.

15. The battery of claim 11, wherein applying the layer of the suspension to the current collector of the battery includes one selected from the group consisting of (i) doctor blade casting, (ii) slot die coating, (iii) reverse comma bar coating, and (iv) spin coating.

16. A vehicle comprising:
a battery including:
a current collector, a layer of a suspension disposed at the current collector, the layer of the suspension applied to the current collector via a method comprising:
providing a slurry including carbon nanotubes, a binder, and a solvent including one selected from the group consisting of (i) water and (ii) N-Methylpyrrolidone (NMP);
operating an ultrasonic homogenizer to form the suspension including the carbon nanotubes and the binder within the solvent; and
applying the layer of the suspension to the current collector of the battery;
with the layer of the suspension applied to the current collector, curing the layer of the suspension at the current collector; and
an electrode coating electrically connected to the current collector, the electrode coating including an active material applied to the cured layer of the suspension.

17. The vehicle of claim 16, wherein the binder includes one selected from the group consisting of (i) carboxy methyl cellulose (CMC), (ii) polyvinylpyrrolidone (PVP), (iii) polyvinylidene fluoride (PVDF), and (iv) polyacrylic acid (PAA).

18. The vehicle of claim 16, wherein the suspension includes a percent weight of carbon nanotubes between 20 percent and 80 percent and a percent weight of binder between 20 percent and 80 percent.

19. The vehicle of claim 16, wherein the cured layer of the suspension at the current collector of the battery has a thickness between 0.1 micrometers and 10 micrometers.

20. The vehicle of claim 16, wherein applying the layer of the suspension to the current collector of the battery includes one selected from the group consisting of (i) doctor blade casting, (ii) slot die coating, (iii) reverse comma bar coating, and (iv) spin coating.
